(19) United States
(12) Patent Application Publication
(10) Pub. No.: US 2010/0077930 A1
(43) Pub. Date: Apr. 1, 2010

(54) Modifications and improvements to griddle table cooking and dining systems

(75) Inventor: Troy Allen Bentz, King George, VA (US)

Correspondence Address: Troy A. Bentz, 6454 St. Pauls Rd, King George, VA, 22485, US

(73) Assignee: Troy Allen Bentz, King George, VA (US)

(21) Appl. No.: 12/286,093

(22) Filed: Sep. 29, 2008

(51) Int. Cl. A47J 37/10

(52) U.S. Cl. 99/422

(57) ABSTRACT

Modifications and improvements to an apparatus used for cooking food on a wide griddle surface, around which meal participants sit, selected from the group consisting of “teppan yaki tables.” The improvements detailed herein to the basic device render it suitable for home use and include safety features to prevent tipping and from aberrant flame behavior from a heat source. Also, a specialized griddle cover is provided for that converts the unit into a home bar. Also, substantial modifications to the basic system entail a method of construction wherein the entire unit can be “broken down” for storage or conversely reassembled in minutes, including a divided griddle surface. Finally, a rigid canopy, suspended over the griddle and table surfaces, for the purpose of mounting lights, audio speakers, other accessories, and for the sake of appearance.

### BACKGROUND OF THE INVENTION

This invention relates to modifications and improvements to apparatuses for griddle cooking systems with large table surfaces around which people sit, watch the cooking process, and eat. The modifications include a canopy, and assembly and safety features of the device to make such a device suitable for home use.

### BACKGROUND

A Japanese dining style, variously called “teppan yaki,” is popular in the restaurants of that country and was developed as part of their historical culture. Teppan yaki cooking was introduced to the United States in the 1960s and has become very popular. This style of cooking is characterized by a large griddle cooking surface, behind which a chef stands and prepares an Oriental-style meal, and around which diners sit and eat. These teppan yaki griddles are typically gas fired. Hundreds of these restaurants are present in the United States, many more around the world, and have come to be known collectively in the United States as “Japanese Steakhouses.”

The teppan yaki griddles in these restaurants are broad, heavy steel griddle surfaces heated from below by liquid propane or natural gas. A large ventilation hood is typically present above the griddle to draw away cooking fumes. A heavy wooden counter-like surface surrounds a fixed griddle table where eight or more diners can be seated, typically. The devices have solid vertical partitions below the wooden dining surfaces to protect the diners from the gas flames beneath the griddle. Teppan yaki tables are now part of the established restaurant culture of the United States. Many people would enjoy employing this cooking system themselves, but a problem exists in that these cooking tables are large fixed devices that are not suitable or practical for home use. The present invention consists of modifications and improvements to the basic restaurant teppan yaki grill design to make it suitable and attractive for home use.

A search of the prior art reveals, for example, U.S. Pat. No. 5,979,431, a gas-fired portable stove designed for outdoor use. This patent includes burners, a griddle, a table-like shelf, and detachable legs, but is not a teppan yaki device around which diners sit and eat, but is rather meant to be a remote food preparation unit, separate from dining. U.S. Pat. No. 6,488,022 details a gas-fired portable outdoor cooker with a griddle surface. However, like the previous patent, this is not a teppan yaki table with provision for seated diners, etc. U.S. Pat. No. 6,343,545 depicts a movable outdoor cooking unit that is gas-fired and incorporates a table surface, but is also not configured for diners sitting around the unit, as with a teppan yaki table.

U.S. Pat. No. 325,318 depicts a barbecue grill with side tables for resting cooking objects and trays, but is not designed to accommodate seated diners around the cooking surface and is not intended as a griddle device. U.S. Pat. No. 5,775,315 depicts a barbecue grill and patio table around which diners sit, observe the grilling process, and eat outdoors. This device does not incorporate a griddle surface, and is a type of barbecue grill, and not a teppan yaki device. Similarly, U.S. Pat. No. 4,840,128 describes another barbecue grill device, apparently aimed at restaurant use, around which people sit, cook, and eat. This patent also does not incorporate a griddle surface and is therefore not a teppan yaki device. U.S. Pat. No. 3,853,115 depicts a broiler system attached to a dining table that incorporates an extensive downdraft fan and duct system to remove cooking fumes. This patent does not make provisions for diners to sit around the cooking unit, as in teppan yaki style, and is not designed for outdoor home use. Similarly, U.S. Pat. Application Publication US 2006/0090743 depicts a device that is a combination barbecue grill, griddle, and wok heating receptacle. This multi-use surface is designed to be suspended above a heating element, like that of a gas grill. This system does incorporate a griddle, but it does not make provisions for diners to sit around the cooking unit, as in the teppan yaki style

U.S. Pat. No. 4,846,146 describes a ventilation and air recycling apparatus for a true teppan yaki table system. This device incorporates a downdraft system for cooking fumes and combustion products and is designed for indoor restaurant use, not for practical home use due to its fixed and elaborate nature. U.S. Pat. No. 4,369,763 depicts an invention that is a modification of a true teppan yaki design in which the griddle system itself is portable and is wheeled around a restaurant to individual, specialized, fixed U-shaped tables where it is “plugged in” when needed, to reduce the number of teppan yaki griddles needed, apparently. This system does not solve the problems of portability to make it suitable for home, outdoor use, either.

U.S. Pat. No. 4,895,131 depicts a combination barbecue grill and griddle system, presumably designed for home use. This system has wheels, wooden eating surfaces that fold down and surround a central griddle surface, and also legs with adjustable length devices to provide a level table surface. This patent embodies one way in which a griddle table could be adapted for home use. U.S. Pat. No. 4,895,131 does not incorporate a number of necessary safety features to protect both the diners and the chef, nor does it provide means by which the unit can be broken down into light component pieces for easy storage and assembly, nor does it provide for means of converting the system for other uses, nor does it provide means of illumination for night use and otherwise giving the system an attractive Oriental appearance. U.S. Pat. No. 4,895,131 features an integral barbecue grill, not a part of the instant invention, and merely depicts something of a basic teppan yaki system—of which no claims are made in the instant invention—and a device that incorporates wheels, folding dining surfaces, dining surfaces comprised of slats, and dining surfaces that completely surround the griddle on four sides—features that the instant invention does not.

### SUMMARY OF INVENTION

The present invention provides a system that can be rapidly assembled from small, manageable components, and then rapidly disassembled for storage in its delivery container. The thick steel griddle surface is the single heaviest component of such a device. The present invention divides this surface into a number of smaller pieces for ease of assembly and handling. The heat source for the griddle may be gas or electric.

A canopy frame is incorporated that is suspended above the unit. A covering for the canopy frame is provided for that can be made of fabric or other suitable materials. This canopy cover is used to establish the “theme” of the unit and may be interchanged: orange fabric with oriental symbols for teppan yaki, for example, or tropical thatch for a “Tiki Bar,” or a Mexican flag motif for Cinco De Mayo, etc. The canopy can be integral to the unit, or free-standing. The canopy may include lights for the purpose of night use, to illuminate the cooking surface and also to enhance the appearance of the unit. The canopy system may include audio speakers to play music, and the structure may also support an array of devices such as Oriental gongs, additional lights, special features, etc. Additionally, a water proof cover for the griddle surface is incorporated that converts the entire unit into a home “Tiki Bar,” when the heat source is not in operation and the system is not in use for cooking and food preparation.

Safety features of the present invention include horizontal supports that extend from the bottom of the legs to against possible tipping. A “flame safety box” is provided that surrounds a gas burner, where employed, and a flame-retardant curtain is provided that surrounds the lower part of the unit to provide additional protection for the diners from abnormal and aberrant flame behavior. A “bumper” is included along the back side of the unit to protect the chef from the hot griddle, as in the restaurant units. Ceramic, or other material, is used to provide a safety region between the eating surfaces (typically wooden) and the griddle surface, as in the restaurant units. A lower exhaust fan may also be incorporated to carry away combustion products to the open, chef-side, of the unit.

### BRIEF DESCRIPTION OF DRAWINGS

Other and further objects, advantages and features of the present invention will be understood by reference to the following specification in conjunction with the accompanying drawings, in which like reference characteristics denote like elements of structure and:

FIG. 1 is a perspective view of a first embodiment of the present invention, fully assembled, exterior view, lower curtain and upper canopy cover in place.

FIG. 2 is a perspective view of another first embodiment of the present invention, fully assembled, without covers and canopies, depicting most internal components.

FIG. 3 is an “exploded” perspective view, detailing system components, some of which were hidden in previous drawings due to perspective.

FIG. 4 is a perspective view of the system for the sole purpose of depicting a waterproof cover that is used to convert the system into an outdoor home bar when not used for cooking. Some parts in all of the figures are omitted for clarity.

### DESCRIPTION OF THE PREFERRED EMBODIMENT

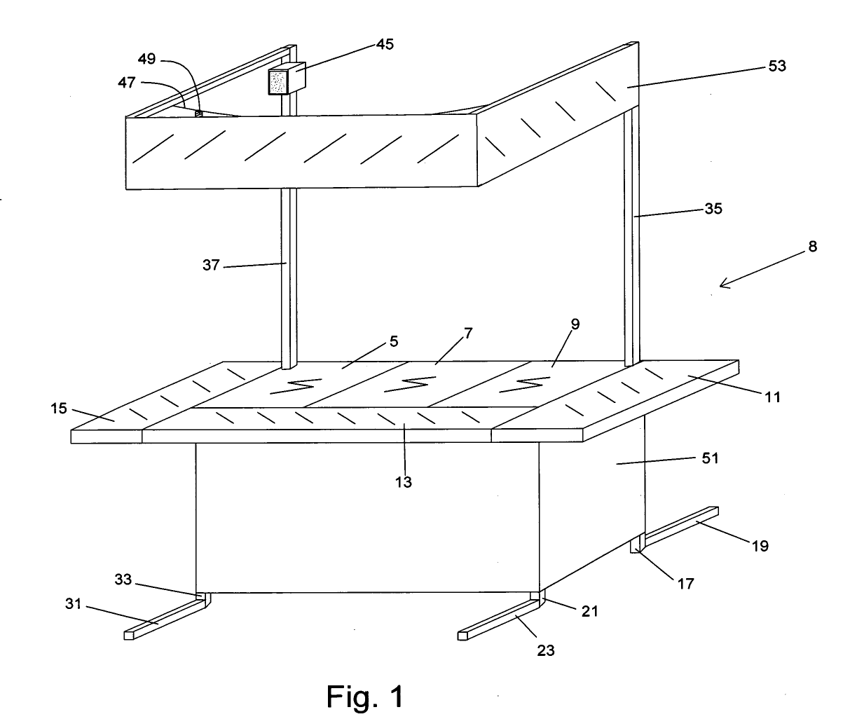

With reference to FIGS. 1 through 3, there is provided an apparatus 8 for cooking and eating in the Japanese teppan yaki style that is suitable in the home environment and that represents an improvement in safety and aesthetics over previous devices, according to a first embodiment of the invention. Cooking and food preparation is performed upon the griddle surfaces 5, 7, and 9. The traditional teppan yaki table has one griddle surface. Three divisions are shown, 5, 7, and 9; however, more or fewer divisions may be employed. This is done for ease of handling and assembly. As mentioned previously, the steel griddle is the heaviest single component of a teppan yaki table. The metal surface of the griddle must be thick enough to distribute heat across a reasonable area, and also not buckle under the effect of the heat source, typically a gas burner, beneath it. The divisions shown are one embodiment. Another embodiment may be, for example, one thinner piece of metal spanning the entire upper, visible griddle space with a thicker piece of metal bonded to the underside of the middle of the surface, making that part of the griddle that is to be under the burner, thicker. Also, other materials, such as glass, etc., may be used to form the griddle surface.

The eating surfaces 11, 13, and 15, surround the griddle on three sides, typically. The eating surfaces in this preferred embodiment are divided into three sections for ease of handling and assembly. The eating sections are typically made of wood, but could be constructed of metal, composite material, or any other suitable material. The sections 11, 13, and 15 connect to one another by quick connection clip devices, and also connect to the main support frame 59.

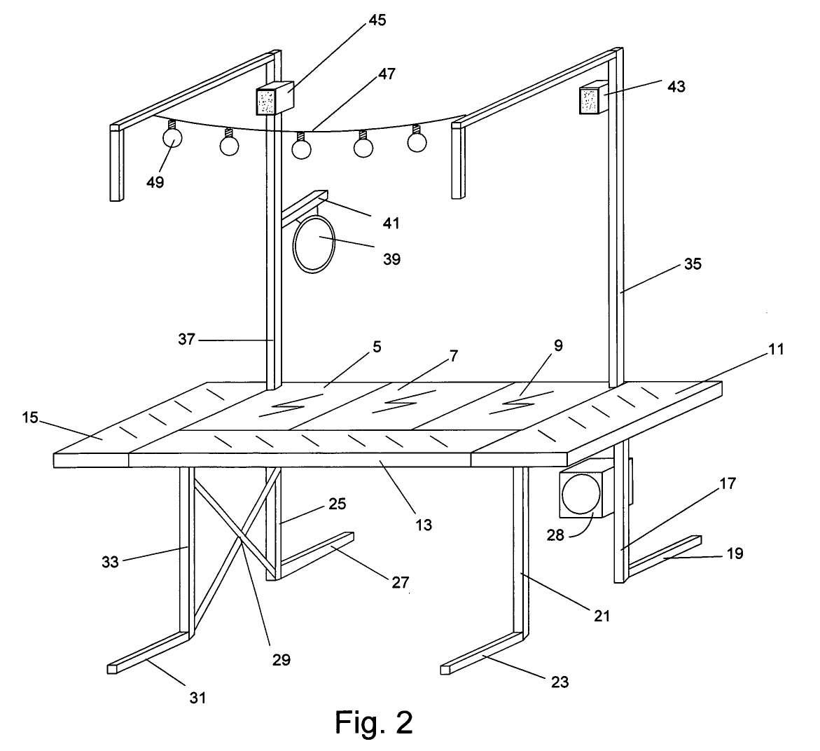

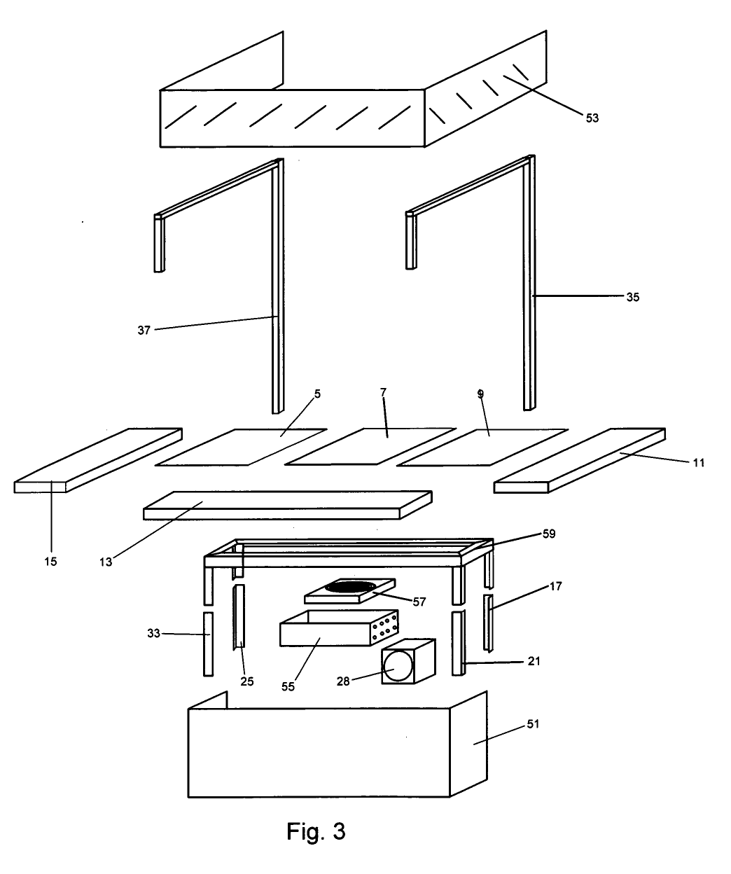

Attached to the main support frame 59 are the four legs 17, 21, 25 and 33. These four legs can be attached and detached for use and easy storage, as shown in FIG. 3, or they may be permanently connected to the main frame 59 and fold down for storage, for example. At the bottom of the four legs 17, 21, 25 and 33 are depicted safety brackets 19, 23, 27 and 31. These brackets may be connected to the legs 17, 21, 25 and 33 by quick connection devices, or could be permanently attached. The brackets may be configured as shown in FIGS. 1 and 2, or may include additional brackets extending to the sides, also-mounted 90 degrees to the depicted bracket. This would prevent tipping in the perpendicular direction, also. In FIG. 3, these supports have been omitted from the drawing for clarity.

FIG. 1 depicts a leg stiffening member 29 attached between two of the legs, 25 and 33. These members stiffen the leg connections and provide stability to the unit. These stiffening members may be used for all of the legs. Stiffening members between the other three leg pairs have been omitted for clarity.

Depicted beneath the table surface in FIG. 3 is the heating unit 57. One or more of these units could be used to provide the heating source for cooking. The unit may be a gas burner; however, an electric heating unit of a fashion could also be employed. Also, depicted is a flame safety box 55 that would surround the heating unit—in the case of a gas burner—and provide additional safety for the chef and the diners from aberrant flame conditions. This flame safety box 55 would be of such a design to allow air to freely enter the burner area for combustion, but mitigate the effects of flame movement toward the sides of the unit, toward the diners and the chef standing at the griddle. Also depicted under the table is an exhaust fan system 28, used to draw away combustion products from under the table surface, away from the diners, and toward the lower open portion of the unit for expulsion. Not shown for clarity is the duct system that would draw away air and combustion products from the flame safety box area.

A lower curtain 51 surrounds the legs and the lower inner structure and components of the device. This curtain 51 creates a pleasing appearance and may be fashioned of fire-resistant material, or have an additional fire- resistant lining, to protect diners against aberrant flame conditions as an additional measure of safety.

Two canopy support members 35 and 37 extend upward from the cooking and eating surface. These members provide means to attach decorative canopy covers 53. These vertical support members 35 and 37 may be integral to the unit or free-standing.

Lights 49 may be suspended from, or attached to, the canopy frame members 35 and 37, behind the canopy cover 53, to illuminate the lower surfaces and also to diffuse light throw the canopy material itself to create a pleasing appearance. These lights are powered by an electrical line 47, and may be suspended from the line itself, or otherwise attached to canopy support members 35 and 37. Electrical lines leading from the canopy to lower parts of the unit have been omitted for clarity. Alternately, the lights may be powered by batteries located within the canopy, or under the cooking and eating surfaces.

Audio speakers 43 and 45 may be affixed to the canopy support structure and provide music to enhance the dining experience. Also, “special devices” such as an Oriental gong, 39, 41, may also be affixed to the canopy support frame and enhance the dining experience. Other special devices could include tinkling bells suspended behind the canopy cover and activated by a wire connected to a foot pedal. Another special device may be a spice shaker, similarly suspended behind the canopy, over the cooking surface, that may be tipped downward, momentarily, for use by a wire-foot pedal apparatus.

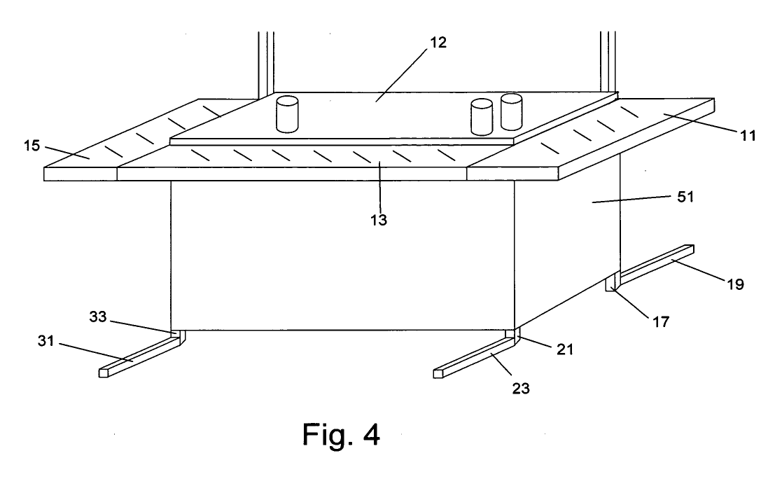

FIG. 4 depicts a waterproof cover 12 that covers the griddle unit, when not used for cooking, and converts the unit into a home bar. The cover 12 may be fashioned with a lip around its periphery to contain spills and may be printed with various designs and lettering, including drink mixing instructions on the portion of the cover near the chef/bartender. The cover may be fashioned of flexible material that can be rolled or folded for storage, or of stiff material. The canopy cover 53 can be configured for a theme matching its use as a bar: natural fiber thatch, for example, is used to create a theme known as the “tiki bar.”

Electric power and, possibly, gas are required to energize the system for use of all of its facilities, including cooking, lights, and music. The heating source 57, as mentioned earlier, may be gas or electric. Bottled gases and electrical extension cords that are required for such operation are not depicted in the drawings, for clarity sake.

Additionally, to protect the unit, a cover may be fashioned to completely cover the unit to provide protection from the rain when left outside. Alternatively, a cover could be fashioned to provide a covering for the lower portion of the unit, only—the canopy and its supporting members disconnected, temporarily.

What is claimed is:

1. Apparatus for cooking on a broad central griddle, surrounded diners, comprising:
a griddle surface that may divide into a plurality of smaller parts;
a table system that is provided with a plurality of safety members on the bottom of the legs to prevent tipping;
a safety screen around legs to protect diners, whether solid or a curtain;
a canopy that overhangs the table;
a system of lights that may be mounted on the canopy;
a system of audio speakers that may be mounted on the canopy;
a collection of components that provides for rapid and easy assembly and disassembly for storage;
a cover that fits over the griddle surface that converts the unit into a home bar.

2. The apparatus of claim 1, further comprising a griddle surface that may be divided in some manner into lighter sections as means for ease of handling, assembly, and disassembly.

3. The apparatus of claim 1, further comprising support members on the bottom of the legs as means to prevent tipping of the unit for safety.

4. The apparatus of claim 1, further comprising a suitable screen that surrounds the lower flame area and separates the diners, as means to provide an additional measure of safety for all participants.

5. The apparatus of claim 1, further comprising a canopy system, suspended above the eating and cooking surfaces by vertical support members that may be integral to the unit, as shown in the figures, or free-standing.

6. The apparatus of claim 1, further comprising lights within the canopy to illuminate both the cooking and eating surfaces, and also the canopy cover, from within, and may be attached to the canopy structure that may extend outside of the canopy system, beyond the cover.

7. The apparatus of claim 1, further comprising audio speakers attached to the canopy by some means.

8. The apparatus of claim 1, wherein the components of the entire system are provided with fittings of various types for rapid assembly and disassembly of the system for storage purposes.

9. The apparatus of claim 1, further comprising a cover system for the griddle that provides means for converting the unit into a home bar.
